(19) United States
(12) Patent Application Publication
(10) Pub. No.: US 2005/0269728 A1
(43) Pub. Date: Dec. 8, 2005

(54) Triglyceride/wax replacement for conventional slack and emulsified waxes used in forest products based composites

(75) Inventor: Kenneth D. Roos, Nicollet, MN (US)

Correspondence Address: STERNE, KESSLER, GOLDSTEIN & FOX PLLC, 1100 NEW YORK AVENUE, N.W., WASHINGTON, DC, 20005, US

(73) Assignee: Archer-Daniels-Midland Company

(21) Appl. No.: 11/134,517

(22) Filed: May 23, 2005

Related U.S. Application Data
(60) Provisional application No. 60/573,408, filed on May 24, 2004.

(51) Int. Cl. B27N 3/02

(52) U.S. Cl. 264/109; 156/62.2; 428/297.4

(57) ABSTRACT

The invention is directed to compositions and methods for enhancing the mechanical strength and dimensional stability of composite boards and structures.

This application claims the benefit of U.S. Provisional Application No. 60/573,408, filed May 24, 2004, which is hereby incorporated herein by reference.

### BACKGROUND OF THE INVENTION

1. Field of the Invention

The present invention relates to compositions and methods for enhancing the mechanical strength and dimensional stability of composite boards and structures.

2. Background and Related Art

Wood is one of the world's most significant renewable resources. However, since the world's supply of large diameter trees for producing lumber and plywood products is decreasing, modern technology is trying to extend the dwindling forest resources. As a result, smaller diameter trees and more species types are being utilized. Hence, the production of oriented strandboard and other wood composites, including particle board and medium density fiberboard, using adhesives as binder, has increased substantially during the last 50 years.

By way of comparison, plywood manufacturing recovers only about 60-70% of the tree stem. Particle board and “oriented strand board” or simply “OSB”, can satisfactorily utilize in the order of 90% of the same tree stem. The composite boards are wooden strand panels bonded with resol resins, urea formaldehyde or isocyanate, and polymeric methylene diphenyl diisocyanates.

In order to make OSB, bark is first stripped from logs, and then, the debarked logs are cut into suitable lengths and fed into a flaker. There, they are reduced into thin flakes which are fractured to produce narrow, thin strands of wood. These wood strands are dried to reduce their moisture content from roughly 50 percent to about 5 percent of the total mass.

Next, the dried strands are blended with a suitable petroleum based “slack” (molten) or emulsified wax and a liquid or dry resin which is a glue that binds the strands together later in the manufacturing process. The petroleum based wax helps repel water in the finished flake board. The strands are then formed into mats with the strands oriented so that the strands of one layer lie crosswise over the strands of the next neighboring layer. The result is a three to five-layer, for example, mat of cross-oriented strands which is several inches thick. Thereafter, the strand-laden sheets are loaded into a press where heat and pressure are applied simultaneously in order to compress the mat to desired thickness and activate the resin, thereby bonding the strands into particle board panels.

When a composite board, such as a particle or OSB board, is made, the wood fibers and adhesive material are placed in a press which applies a pressure for several minutes. The total time in the press varies with the parameters of the mat and with the resin technologies that are used. The thicker the mat, the longer the press time. The adhesive bonds the wood particles together so that they become a completed self-sustaining panel by the time that the press opens.

It is desirable to accomplish increased bond strength and dimensional stability in these manufactured products through a use of renewable agricultural or animal products, as distinguished from the use of a depleting resource, such as petroleum based products.

Vegetable oils or animal fats hydrogenated to low or very low iodine values (“IV”), also known as iodine numbers, or fats naturally composed primarily of saturated triglycerides (such as palm oil or fractionated fats) can be used alone or in blend formulations with adhesives/laminants to achieve an enhanced water tolerance for composite materials.

Drying oils are triglycerides which have the ability to dry or polymerize. Text material on drying oils is found, for example, in Bailey's Industrial Oils and Fats Products, A Wiley-Interscience Publications, John Wiley and Sons, Inc. 1996. Some examples of drying oils are: linseed, fish, soybean, tall, tung, castor and oiticica. Drying oils are composed of fatty acids which have a preponderance of two or three double bonds. The drying ability of these oils is related to their Iodine Value (“IV”), which is a quantitative measure of the number of double bonds that they contain. Oils in the range of 195-170 IV are relatively fast-drying. Oils in the range of 140-120 IV are semi-drying, and oils with IV's under 120 are non-drying.

Drying oils include conjugated oils such as tung oil and Archer 1, a modified conjugated linseed oil. The term “conjugation” is used herein to describe triglycerides which have double bonds on adjacent carbon atoms. For natural oils containing more than one carbon to carbon double bond, the double bonds are generally separated by a methylene group, commonly referred to as being methylene interrupted. These fats and oils have nutritional benefits; however, the methylene interruption limits their use in industrial polymerization applications, where they could find use as coatings, adhesives and the like. For these fats and oils to be so used industrially, they need to polymerize rapidly. For this to occur, it is advantageous to have the double bonds adjacent to one another or conjugated (i.e., the methylene interrupt is shifted or relocated).

The iodine values or numbers are a measure of the iodine absorbed in a given time by a chemically unsaturated material, such as a vegetable oil and is used to measure the unsaturation or number of double bonds of a compound or mixture. Examples of saturated triglycerides having a low iodine value (a range of Iodine Values of about 0-70, with 0-30 preferred) may be produced by a hydrogenation of a commercial oil or fat, such as oils of: soybean, soy stearine, stearine, corn, cottonseed, rape, canola, sunflower, fish, lard, tallow, palm, palm kernel, coconut, crambe, peanut, tall oil, animal fats, and blends thereof. These oils may also be produced from genetically engineered plants to obtain low IV oil with a high percentage of fatty acid.

Triglycerides such as linseed oil have a long history of use as a water repellent for solid wood when used alone or as an integral component of paint formulations designed for coating wood products. U.S. Pat. No. 6,277,310 describes material for enhancing water tolerance of composite boards by a use of a melted triglyceride. U.S. Pat. No. 6,001,286 describes a material for enhancing water tolerance of composite boards. U.S. Pat. No. 5,607,633 and U.S. Pat. No. 5,942,058 describe co-adhesive systems for bonding wood, fibers, or agricultural based composite materials. U.S. Pat. No. 5,719,301 describes a method of conjugating double bonds in drying oils. U.S. Pat. No. 6,686,056 describes a reactive copper-oil based system for increased dimensional stability in panel products.

It was desired to produce an emulsion that has low viscosity, long term stability, is shear stable, and is compatible with the resins and other additives currently used by the industry. It was also desired to produce a slack form of the wax and oil mixture that has long term stability and is compatible with the resins and other additives currently used by the industry.

### BRIEF SUMMARY OF THE INVENTION

It is a general object of the invention to provide a method of enhancing the mechanical strength and dimensional stability of composite boards and structures.

It is a further specific object of the invention to provide a method of enhancing the mechanical strength and dimensional stability of composite boards and structures comprising: (a) applying a combination of a homogeneous triglyceride and wax emulsion comprising a surfactant, and a bonding agent to fibrous plant or wood materials; and (b) subjecting the materials to a press cycle to form a bonded fibrous composition.

It is another specific object of the invention to provide a method of enhancing the mechanical strength and dimensional stability of composite boards and structures comprising: (a) applying a combination of a slack form of a triglyceride and wax mixture, and a bonding agent to fibrous plant or wood materials; and (b) subjecting the materials to a press cycle to form a bonded fibrous composition.

It is another general object of the invention to provide a composite board or structure.

It is another specific object of the invention to provide a composite board or structure made by the methods of the present invention.

It is a further general object of the invention to provide a composition for enhancing the mechanical strength and dimensional stability of composite boards and structures.

It is a further specific object of the invention to provide a composition for enhancing the mechanical strength and dimensional stability of composite boards and structures comprising a triglyceride, wax, and a surfactant, wherein the composition is a homogeneous, stable emulsion.

It is a further specific object of the invention to provide a composition for enhancing the mechanical strength and dimensional stability of composite boards and structures comprising a triglyceride and wax, wherein the composition is a stable slack (molten) material.

### DETAILED DESCRIPTION OF THE INVENTION

The present invention is directed to compositions and methods for enhancing the mechanical strength and dimensional stability of composite boards and structures.

In one embodiment, there is provided a method of enhancing the mechanical strength and dimensional stability of composite boards and structures.

In a further embodiment, a method of enhancing the mechanical strength and dimensional stability of composite boards and structures is provided comprising: (a) applying a combination of a homogeneous triglyceride and wax emulsion comprising a surfactant, and a bonding agent to fibrous plant or wood materials; and (b) subjecting the materials to a press cycle to form a bonded fibrous composition.

In yet a further embodiment, a method of enhancing the mechanical strength and dimensional stability of composite boards and structures is provided comprising: (a) applying a combination of a slack form of a triglyceride and wax mixture, and a bonding agent to fibrous plant or wood materials; and (b) subjecting the materials to a press cycle to form a bonded fibrous composition.

In another embodiment, a method of enhancing the mechanical strength and dimensional stability of composite boards and structures is provided comprising: (a) applying a combination of a homogeneous triglyceride and wax emulsion comprising a surfactant, and a bonding agent to fibrous plant or wood materials; and (b) subjecting the materials to a press cycle to form a bonded fibrous composition, wherein the homogeneous triglyceride and wax emulsion and the bonding agent are blended into a mixture prior to application to the fibrous plant or wood materials.

In a further embodiment, a method of enhancing the mechanical strength and dimensional stability of composite boards and structures is provided comprising: (a) applying a combination of a slack form of a triglyceride and wax mixture, and a bonding agent to fibrous plant or wood materials; and (b) subjecting the materials to a press cycle to form a bonded fibrous composition, wherein the homogeneous triglyceride and wax emulsion and the bonding agent are blended into a mixture prior to application to the fibrous plant or wood materials.

In one embodiment, the triglyceride and wax emulsion can be further mixed with water prior to use. In a further embodiment, the triglyceride and wax emulsion can be used neat.

In another embodiment, any of a number of different surfactants or emulsifying agents can be used in the present invention. The choice of surfactants or emulsifying agents depends upon desired properties and chemical compatibility with other additives used in the manufacture of wood based composites.

Different processes in the wood products industry may require different chemical attributes from the final triglyceride and wax emulsion. Determination of these attributes would be within the capabilities of one skilled in the relevant art. For example, wet process hardboard would require an emulsion that would break easily once added to the water slurry so as to cleat the wax and oil component onto the fiber. A different chemistry may need to be utilized in the manufacture of oriented strand board as to minimize any effects upon resin cure during the pressing operation. In the situation of particleboard, it is often common to mix the wax emulsion and urea formaldehyde resin together. Therefore, the chemistries between the two need to be compatible.

The triglyceride and wax emulsion can be manufactured as a nonionic, anionic, or cationic emulsion depending upon the chemistry of the emulsifiers being used and the desired final composition of the emulsion. In addition, the triglyceride and wax emulsion can be classified as a water in oil emulsion or an oil in water emulsion depending on the percentage of oil to water. Further, stabilizers and thickeners can be added to yield other desired attributes of the final emulsion. Some examples of these include guar gum, wheat starch, corn starch, methyl cellulose, hydroxpropylcellulose, carboxymthylcellulose, wheat flour, corn flour, pregelatinized corn flour, pregelatinized wheat flour, fumed silica, soy flour, xanthan gum, gluten, and mixtures thereof.

Examples of surfactants or emulsifying materials that can be used in the present invention are a wide range of fatty acids, tall oils, sorbitan esters, phosphate esters, fatty alcohol ethoxylates, phosphate esters, sulphosuccinates, ligno sulphonates, polyester polyols, alcohol ethoxylates, soy lecithins, sorbitan oleates, wide range of caustics, sorbitan sterates, steric acids, palmitic acids, cetyl esters, polysorbates, glycerol sterates, polyethelyne glycols (PEGs), cetyl alcohols, oleic acids, mono and diglycerides, sulfanates, linear alcohol sulfanates, and mixtures thereof.

In a further embodiment, any number of different triglycerides or combinations of triglycerides can be used in the present invention. Examples of triglycerides that can be used in the present invention are linseed oil, soybean oil, soy stearine oil, stearine oil, corn oil, cottonseed oil, rape seed oil, canola oil, sunflower oil, safflower oil, tung oil, castor oil, china wood oil, fish oil, lard, tallow, palm oil, palm kernel oil, coconut oil, crambe oil, peanut oil, tall oil, oiticica oil, animal fats, and mixtures thereof.

In another embodiment, any number of different waxes or combinations of waxes can be used in the present invention, such as petroleum waxes or natural waxes. Examples of petroleum waxes that can be used in the present invention are petroleum scale, slack, paraffin, and micro paraffin waxes. Examples of natural waxes that can be used in the present invention are hydrogenated vegetable waxes (sterines) from soybean oil, corn oil, palm oil, cottonseed oil, canola oil, sunflower oil, safflower oil, and animal fats. Some other natural waxes include bees wax, carnuba wax, candelilla wax, bayberry wax, orange wax, and mixtures thereof.

In a further embodiment, any number of different bonding agents or combinations of bonding agents can be used in the present invention. Examples of bonding agents that can be used in the present invention are an adhesive resin, an emulsion of adhesive resin and water, a conjugated triglyceride co-adhesive, urea-formaldehyde, melamine-urea-formaldehyde, polyvinyl acetate, phenol formaldehyde, isocyanate, di-isocyanate, resorcinol-phenol-formaldehyde, protein, tannin-formaldehyde, sulfite liquor, and mixtures thereof.

In another embodiment, any number of different fibrous plant or wood materials, or combinations of fibrous plant and wood materials can be used in the present invention. Examples of fibrous plant and wood materials that can be used in the present invention are wood, wood fibers, agricultural fibers, agricultural materials, mixtures thereof, and mixtures of these materials with plastics or polymers.

In one embodiment, a composite board or structure made by the methods of the present invention is provided.

In a further embodiment, a composite board or structure made by the methods of the present invention is provided, wherein the composite board or structure comprises or is selected from the group comprising oriented strand board (OSB), particle board, plywood, medium density fiberboard (MDF), hardboard, formed molded shapes, paper board, insulation board, corrugated cardboard, gypsum, fiberboard sheathing, and cement-fiber boards.

In another embodiment, a composition for enhancing the mechanical strength and dimensional stability of composite boards is provided.

In a further embodiment, a composition for enhancing the mechanical strength and dimensional stability of composite boards and structures comprising a triglyceride, a wax, and a surfactant is provided, wherein the composition is a homogeneous, stable emulsion.

In yet a further embodiment, a composition for enhancing the mechanical strength and dimensional stability of composite boards and structures comprising a slack form of a triglyceride and wax mixture is provided.

In another embodiment, a composition for enhancing the mechanical strength and dimensional stability of composite boards and structures comprising a triglyceride, a wax, and a surfactant is provided, wherein the composition is a homogeneous, stable emulsion, and wherein said composition has a pH that is near neutral.

In a further embodiment, a composition for enhancing the mechanical strength and dimensional stability of composite boards and structures comprising a triglyceride, a wax, and a surfactant is provided, wherein said composition is a homogeneous, stable emulsion, wherein said stable emulsion is subjected to continuous mixing, stirring, or other form of agitation of said emulsion or emulsion mixed with other additives used in the manufacture of these composites.

In one embodiment, the homogeneous, stable emulsion of wax and triglyceride are in a relative proportion to each other equivalent to: about 99% wax and about 1% triglyceride; about 95% wax and about 5% triglyceride; about 90% wax and about 10% triglyceride; about 85% wax and about 15% triglyceride; about 80% wax and about 20% triglyceride; about 75% wax and about 25% triglyceride; about 70% wax and about 30% triglyceride; about 65% wax and about 35% triglyceride; about 60% wax and about 40% triglyceride; about 55% wax and about 45% triglyceride; about 50% wax and about 50% triglyceride; about 45% wax and about 55% triglyceride; about 40% wax and about 60% triglyceride; about 35% wax and about 65% triglyceride; about 30% wax and about 70% triglyceride; about 25% wax and about 75% triglyceride; about 20% wax and about 80% triglyceride; about 15% wax and about 85% triglyceride; about 10% wax and about 90% triglyceride; about 5% wax and about 95% triglyceride; and about 1% wax and about 99% triglyceride.

In another embodiment, the homogeneous slack (molten) mixture of wax and triglyceride are in a relative proportion to each other equivalent to: about 99% wax and about 1% triglyceride; about 95% wax and about 5% triglyceride; about 90% wax and about 10% triglyceride; about 85% wax and about 15% triglyceride; about 80% wax and about 20% triglyceride; about 75% wax and about 25% triglyceride; about 70% wax and about 30% triglyceride; about 65% wax and about 35% triglyceride; about 60% wax and about 40% triglyceride; about 55% wax and about 45% triglyceride; about 50% wax and about 50% triglyceride; about 45% wax and about 55% triglyceride; about 40% wax and about 60% triglyceride; about 35% wax and about 65% triglyceride; about 30% wax and about 70% triglyceride; about 25% wax and about 75% triglyceride; about 20% wax and about 80% triglyceride; about 15% wax and about 85% triglyceride; about 10% wax and about 90% triglyceride; about 5% wax and about 95% triglyceride; and about 1% wax and about 99% triglyceride.

In yet another embodiment the homogeneous, stable emulsion of wax and triglyceride are in a relative proportion to each other equivalent to: between about 90% to about 99% wax and between about 1% to about 10% triglyceride; between about 80% to about 89% wax and between about 11% to about 20% triglyceride; between about 70% to about 79% wax and between about 21% to about 30% triglyceride; between about 60% to about 69% wax and between about 31% to about 40% triglyceride; between about 50% to about 59% wax and between about 41% to about 50% triglyceride; between about 40% to about 49% wax and between about 51% to about 60% triglyceride; between about 30% to about 39% wax and between about 61% to about 70% triglyceride; between about 20% to about 29% wax and between about 71% to about 80% triglyceride; between about 10% to about 19% wax and between about 81% to about 90% triglyceride; and between about 1% to about 9% wax and between about 91% to about 99% triglyceride.

In a further embodiment the homogeneous slack (molten) mixture of wax and triglyceride are in a relative proportion to each other equivalent to: between about 90% to about 99% wax and between about 1% to about 10% triglyceride; between about 80% to about 89% wax and between about 11% to about 20% triglyceride; between about 70% to about 79% wax and between about 21% to about 30% triglyceride; between about 60% to about 69% wax and between about 31% to about 40% triglyceride; between about 50% to about 59% wax and between about 41% to about 50% triglyceride; between about 40% to about 49% wax and between about 51% to about 60% triglyceride; between about 30% to about 39% wax and between about 61% to about 70% triglyceride; between about 20% to about 29% wax and between about 71% to about 80% triglyceride; between about 10% to about 19% wax and between about 81% to about 90% triglyceride; and between about 1% to about 9% wax and between about 91% to about 99% triglyceride.

In another embodiment, the homogeneous, stable emulsion of wax and triglyceride are in a relative proportion to each other equivalent to: 99% wax and 1% triglyceride; 95% wax and 5% triglyceride; 90% wax and 10% triglyceride; 85% wax and 15% triglyceride; 80% wax and 20% triglyceride; 75% wax and 25% triglyceride; 70% wax and 30% triglyceride; 65% wax and 35% triglyceride; 60% wax and 40% triglyceride; 55% wax and 45% triglyceride; 50% wax and 50% triglyceride; 45% wax and 55% triglyceride; 40% wax and 60% triglyceride; 35% wax and 65% triglyceride; 30% wax and 70% triglyceride; 25% wax and 75% triglyceride; 20% wax and 80% triglyceride; 15% wax and 85% triglyceride; 10% wax and 90% triglyceride; 5% wax and 95% triglyceride; and 1% wax and 99% triglyceride.

In a further embodiment, the homogeneous slack (molten) mixture of wax and triglyceride are in a relative proportion to each other equivalent to: 99% wax and 1% triglyceride; 95% wax and 5% triglyceride; 90% wax and 10% triglyceride; 85% wax and 15% triglyceride; 80% wax and 20% triglyceride; 75% wax and 25% triglyceride; 70% wax and 30% triglyceride; 65% wax and 35% triglyceride; 60% wax and 40% triglyceride; 55% wax and 45% triglyceride; 50% wax and 50% triglyceride; 45% wax and 55% triglyceride; 40% wax and 60% triglyceride; 35% wax and 65% triglyceride; 30% wax and 70% triglyceride; 25% wax and 75% triglyceride; 20% wax and 80% triglyceride; 15% wax and 85% triglyceride; 10% wax and 90% triglyceride; 5% wax and 95% triglyceride; and 1% wax and 99% triglyceride.

In another embodiment the homogeneous, stable emulsion of wax and triglyceride are in a relative proportion to each other equivalent to: between 90% to 99% wax and between 1% to 10% triglyceride; between 80% to 89% wax and between 11% to 20% triglyceride; between 70% to 79% wax and between 21% to 30% triglyceride; between 60% to 69% wax and between 31% to 40% triglyceride; between 50% to 59% wax and between 41% to 50% triglyceride; between 40% to 49% wax and between 51% to 60% triglyceride; between 30% to 39% wax and between 61% to 70% triglyceride; between 20% to 29% wax and between 71% to 80% triglyceride; between 10% to 19% wax and between 81% to 90% triglyceride; and between 1% to 9% wax and between 91% to 99% triglyceride.

In yet another embodiment the homogeneous slack (molten) mixture of wax and triglyceride are in a relative proportion to each other equivalent to: between 90% to 99% wax and between 1% to 10% triglyceride; between 80% to 89% wax and between 11% to 20% triglyceride; between 70% to 79% wax and between 21% to 30% triglyceride; between 60% to 69% wax and between 31% to 40% triglyceride; between 50% to 59% wax and between 41% to 50% triglyceride; between 40% to 49% wax and between 51% to 60% triglyceride; between 30% to 39% wax and between 61% to 70% triglyceride; between 20% to 29% wax and between 71% to 80% triglyceride; between 10% to 19% wax and between 81% to 90% triglyceride; and between 1% to 9% wax and between 91% to 99% triglyceride.

The remainder of the specification will focus on oriented strand boards “OSB”, by way of example; however, this concentration on OSB is for convenience of this description and does not limit the invention thereto. The invention is applicable to at least plywood, particle board, OSB and all similar boards, and other composite structures. Some of these are insulation board, paper board, corrugated cardboard, medium density fiberboard, hardboard, gypsum, fiberboard sheathing, and cement-fiber boards.

### EXAMPLES

Several laboratory studies were conducted with the standard grade and value added grade of these new wax/triglyceride emulsions, with linseed oil being the triglyceride chosen to test. The wax/linseed oil emulsion may also be referred to as “Linwax” or “Linwax Emulsions.”

Initial tests were initiated at a powder phenolic OSB facility that was having problems maintaining adequate dimensional stability in their finished panels on a consistent basis. At the time the facility was using a conventional paraffin wax emulsion as their sizing agent.

Linseed oil was mixed with the wax emulsion on site and the mixture was sprayed onto the furnish in the blender per normal practice. Test data from the finished panels indicated a significant improvement in dimensional stability. Linear expansion values seemed to be improved as well. Another more surprising outcome from the trials was that the dust in the plant generally but particularly around the blenders and formers was significantly reduced. It seemed the linseed oil component of the final mixture improved the utilization of the powder resin.

After a series of trials at this OSB location it was determined that a mix of 70% wax solids to 30% linseed oil solids gave optimal performance for commodity sheathing products. Trials were also conducted at OSB plants using liquid phenolic resins and similar results were obtained.

Further research effort was focused on the production of a homogeneous linseed oil/petroleum wax emulsion for use as a sizing agent for oriented strand board. Based on results from the previous trials, it was clear that there was potential for two types of products. The first of these could be described as a commodity grade linseed oil/wax emulsion for sheathing type products that could substitute for existing paraffin wax emulsion systems. The second is the concept of a high performance product aimed at value added OSB panels.

In the following studies, the type of emulsifiers used to manufacture the Linwax emulsion were termed A and B. Package A is a nonionic emulsion based on ethoxylated sorbitan fatty acid esters and sorbitan fatty acid esters. Package B is an anionic emulsion based on fatty acids and amines.

The emulsions developed are very compatible and miscible with liquid phenolic resins. The near neutral pH of the emulsion eliminates (minimizes) any potential interactions with phenolic, isocyanate, and ureaformaldehyde resins. The finished emulsion has a yellowish-white coloration and pleasant mild odor.

The following reports detail the manufacturing parameters and resulting panel properties.

Study 1:

The objective of this study was to compare the properties of the commodity grade Linwax emulsion with the conventional paraffin wax emulsion supplied by Borden in the manufacture of powder phenolic bonded OSB.

Strands used were from a northern MN OSB mill comprised of mainly aspen with a percentage of birch, red pine, and balm mixed in. The face and core resin and the Borden EW58S emulsion were supplied by the same mill. The resin was applied at 2.5% solids addition rate to both face and core. Both waxes were applied at a 1.0% solids addition rate to both the face and core. Furnish was mixed in a batch type blender with the wax being applied by a Coil spinning disc atomizer. Mats were of random orientation and pressed at 400° F. for 3.5 minutes including degas. Target thickness was ½-inch at a density of 40 pcf. Three panels per wax combination were manufactured. Panels were allowed to sit overnight prior to testing. Panels were tested for mechanical strength and dimensional stability.

The results from the testing are as follows:

| | | % Water | % Thickness |
|---|---|---|---|
| | Mechanical (psi) | Absorption | Swell |
| Control | 45.2 | 39.0 | 19.6 |
| Linwax | 52.5 | 30.4 | 14.3 |

The Linwax resulted in a significant (P<0.05) reduction in both thickness swell and water absorption. The higher mechanical value may be a result of better resin utilization by using the Linwax. During running of the combined linseed oil and wax at the mill it was determined that the linseed oil created better adhesion of the powder resin to the strands and less dust in the plant around the blenders and formers.

Study 2:

The second study evaluated commodity grade Linwax used in combination with liquid phenolic resin in comparison to Borden's EW-58S with the same resin

Strands were supplied by a southern OSB mill and comprised mainly of southern yellow pine with a percentage of black gum mixed in. These strands were not the best quality. The fines content and the proportion of broken strands was high. Liquid phenolic resin was used as the binder at a 3.2% solids loading for the face and core. The Linwax and EW-85S emulsion were applied at a 1.0% solids loading level to both the face and core in a batch type blender utilizing a Coil spinning disc atomizer.

Mats were formed with random orientation then pressed on screens at 400° F. for a total press time of 3.5 minutes. Target density was 42 pcf at a final thickness of ½-inch. Panels were allowed to sit overnight prior to testing. Three panels per wax combination were manufactured. Panels were tested for mechanical, water absorption and thickness swell

Comparative test results are summarized below:

| | | % Water | % Thickness |
|---|---|---|---|
| | Mechanical (psi) | Absorption | Swell |
| Control - EW 58S | 44.5 | 46.9 | 35.3 |
| Linwax | 48.6 | 44.0 | 30.8 |

As with the previous investigation the Linwax demonstrated a significant (P<0.05) reduction in thickness swell compared to the EW58-S. Water absorption in this study was not significantly different between the groups.

Study 3:

The purpose of this study was to evaluate the potential of high performance value added Linwax emulsions to enhance the dimensional stability of thicker OSB panels such as those that are used for flooring. In contrast to the commodity Linwax formulations used in Studies 1 and 2 the linseed oil wax ratio was change to a 1:1 solids ratio of wax and linseed oil.

Strands were obtained from a Northern OSB facility and comprised of mainly aspen with a percentage of white birch, red pine, and balm mixed in. Liquid phenolic resin from another northern mill was utilized in the study. Face and core resin was applied at a 5.0% solids addition level. The Linwax was applied at 6.0% solids level for the face and 2.0% solids level in the core. In this study given the compatibility of the liquid phenolic resin and the Linwax, appropriate ratios of the two were combined prior to application to the strands. The combined material was applied to the strands using a Coil spinning disc atomizer.

Mats were formed randomly and pressed at 410° F. for 5.5 minutes total press time. Target density was 42 pcf with a final thickness of ¾-inch. Panels were allowed to sit overnight prior to testing.

The high addition rates of linseed oil and wax in the face layers of the panels did not hinder the bonding of the phenolic resin. The average mechanical value for the panels was 67 psi. All mechanical breaks were in the core area of the samples.

The impact on dimensional stability was positive and very significant. Similarly the mean water absorption value for the panels was 14.0% and the thickness swell was only 2.6% after a 24-hour water soak In addition the surface of the test samples was very smooth with little flake distortion after testing.

The conclusion from the study was that a 1:1 linseed oil wax combination Linwax is very well suited for the production of value added OSB products with enhanced dimensional stability.

Study 4:

Another study was conducted to evaluate compare the performance of panel manufactured with an homogeneous Linwax loading throughout the panel with panels containing Linwax made with a differential face and core loading.

Three sets of laboratory panels were manufactured for this evaluation. Two experimental sets and one control set. Three panels were manufactured per set. Blending, forming, and pressing parameters were constant for all three sets with the exception of the sizing agent material and amounts in the face and core layers.

The control set panels contained 1% of a petroleum based wax emulsion. One set experimental set contained 4% Linwax in the face and core layers while the other set contained 6% in the face layer and 2% in the core layer.

The resin used for this evaluation was liquid phenolic. Unlike typical wax emulsions, the Linwax sizing agent is compatible with liquid phenolic resins and can be combined with the resin prior to blending and applied as one system.

Wax and resin were applied in a batch blender using a Coil spinning disc atomizer. The addition rate for the resin for all sets and face and core layers was 3.5%. Strands were formed into mats with a random orientation. The face to core ratio was 50:50.

Panels were pressed using typical mill pressing parameters. Press temperature was 425° F., target thickness was ½-inch with a target density of 39 pcf. Press cycle time was 4.0 minutes including degas.

Testing: Panels were allowed a twenty-four hour cure time prior to testing. Panels were tested for mechanical strength, water absorption, thickness swell, strength (MOR), stiffness (MOE), and wet strength (wet MOR).

Results are summarized in the following tables:

TABLE ONE
Mechanical test data:

| | IB | Wet MOR | MOE | MOR |
|---|---|---|---|---|
| Group | (psi) | (psi) | (psi) | (psi) |
| Control mean | 43.2 | 1897.4 | 690304 | 4376 |
| StdDev | 20.6 | 295.5 | 78180 | 1220 |
| n | 24 | 5 | 4 | 4 |
| 4% Linwax | 44.5 | 2437.2 | 636537 | 4474 |
| Mean | | | | |
| StdDev | 11.8 | 584.8 | 103362 | 595 |
| n | 24 | 5 | 4 | 4 |
| 6%/2% | 45.4 | 2708.5 | 642143 | 4600 |
| Linwax | | | | |
| Mean | | | | |
| StdDev | 17.7 | 676.7 | 113125 | 1450 |
| n | 24 | 5 | 4 | 4 |

TABLE TWO
Physical test data:

| | Water Absorption | Thickness Swell |
|---|---|---|
| Group | (%) | (%) |
| Control mean | 39.0 | 13.3 |
| StdDev | 5.7 | 2.2 |
| n | 9 | 9 |
| 4% Linwax Mean | 36.6 | 11.1 |
| StdDev | 7.9 | 2.4 |
| n | 9 | 9 |
| 6%/2% Linwax Mean | 32.0 | 8.3 |
| StdDev | 5.5 | 1.6 |
| n | 9 | 9 |

Table 1 shows that the mechanical values for all three sets only varied by two psi, with the mean at 44.5 psi. It is also apparent that strength and stiffness values for were not affected by the addition of Linwax. Both sets of boards containing Linwax had a higher wet MOR value than the control set.

Table 2 shows that the addition of Linwax to the panels greatly improved the water absorption and thickness swell properties of the panels. Thickness swell in the set containing the higher face loading of Linwax was significantly lower than the set with 4% Linwax distributed throughout the panel.

From the above results, it can be concluded that the Linwax sizing agent can be used with increased addition rates without reducing mechanical panel properties, while reducing physical properties. In addition the transfer of sizing agent from the core to the face layers also improves the efficacy of the sizing agent.

TABLE 3
Various Examples of Linseed/Slack Wax Emulsion Combinations:

| | | Typical | Sample | | | |
|---|---|---|---|---|---|---|
| Sample | Base Wax | Average | Solids | Viscosity | | Surfactant |
| Number | Combination | solids (%) | (%) | (Cps) | pH | Package |
| 44 | 70% | 50 | 52.6 | 24 | 7.6 | A |
| | slack/30% | | | | | |
| | linseed | | | | | |
| 53 | 50% | 50 | 55.5 | 24 | 7.4 | A |
| | slack 750% | | | | | |
| | linseed | | | | | |
| 54 | 70% | 50 | 58.0 | 24 | 7.4 | A |
| | slack/30% | | | | | |
| | linseed | | | | | |
| 54 | 70% | 60 | Na | Na | Na | A |
| | slack/30% | | | | | |
| | linseed | | | | | |
| 58 | 70% | 70 | 69.1 | 292 | 7.4 | A |
| | slack/30% | | | | | |
| | linseed | | | | | |
| 66 | 70% | 50 | 53.0 | 55 | 8.5 | B |
| | slack/30% | | | | | |
| | linseed | | | | | |
| 68 | 70% | 50 | 53.0 | 20 | 7.6 | A |
| | slack/30% | | | | | |
| | linseed | | | | | |
| 69 | 50% | 50 | 52.0 | 20.5 | 7.6 | A |
| | slack/50% | | | | | |
| | linseed | | | | | |
| 69 | 50% | 60 | 60.5 | 37 | 7.5 | A |
| | slack/30% | | | | | |
| | linseed | | | | | |
| 70 | 70% | 50 | 50.0 | 20 | 8.2 | B |
| | slack/30% | | | | | |
| | linseed | | | | | |
| 70A | 70% | 60 | 60.0 | 131 | 8.1 | B |
| | slack/30% | | | | | |
| | linseed | | | | | |

Study 5:

Introduction: It was the intent of this study to have an independent third party facility, Mississippi State University, verify that the Linwax formulation performs comparable or better to other current commercially available wax emulsions on the market. A further intent of this study was to judge the ease of use of the products and methods in a mock production facility.

Procedure: Two gallons of Linwax formulation #54 (see table 3 under Study 5) was sent to MSU for the project. The remainder of materials were supplied by Potlatch Corporation. This included powder resin for the face and core layers, commercially produced EW-58S from Borden, and strands comprising of mainly aspen with a percentage of birch, red pine, and balm mixed in up to 25% combined.

Furnish was mixed in a batch type blender with 2.5% powder resin for both the face and core, and either 0.8% or 1.3% wax solids of the two waxes being compared. Also, a group of panels was manufactured with no wax to serve as controls.

The blended furnish was formed into 36-inch by 36-inch mats with random orientation. Mats were transferred into a hydraulic hot press. They were pressed at 410° F. for 4.0 minutes to a target thickness of ½-inch and final density of 38 pcf. Panels were allowed to hot stack over night prior to trimming. Three panels were pressed for the set of controls with no wax. Six panels were pressed per wax type and loading. Test specimens were allowed to condition one week prior to testing. Testing included bending, dry mechanical, boiled mechanical, water absorption and thickness swell.

Discussion and Results: The data was compiled for each panel property evaluated and is summarized in the following tables.

| | | Density | Dry IB | Boil IB | MOE | MOR |
|---|---|---|---|---|---|---|
| Group | | (pcf) | (psi) | (psi) | (psi) | (psi) |
| No Wax | Mean | 37.0 | 28.1 | 0.0 | 449231 | 2261 |
| 0.8% EW 58S | Mean | 37.6 | 62.3 | 19.7 | 520707 | 3542 |
| 0.8% Linwax | Mean | 37.5 | 56.0 | 22.3 | 493313 | 3240 |
| 1.3% EW 58S | Mean | 38.3 | 58.2 | 25.8 | 535945 | 3385 |
| 1.3% Linwax | Mean | 36.7 | 59.6 | 26.9 | 505893 | 3299 |

| | 2 Hr | 24 Hr | 48 Hr | 2 Hr | 24 Hr | 48 Hr |
|---|---|---|---|---|---|---|
| | TS | TS | TS | WA | WA | WA |
| Group | (%) | (%) | (%) | (%) | (%) | (%) |
| No Wax | 50.3 | 54.1 | 55.2 | 91.7 | 104.3 | 111.3 |
| 0.8% EW 58S | 13.0 | 26.6 | 31.1 | 12.27 | 34.2 | 47.9 |
| 0.8% Linwax | 9.8 | 26.7 | 33.6 | 8.2 | 36.1 | 55.6 |
| 1.3% EW 58S | 8.4 | 21.7 | 29.0 | 8.9 | 26.2 | 42.1 |
| 1.3% Linwax | 7.9 | 24.0 | 30.8 | 6.3 | 31.5 | 53.6 |

There were no concerns or issues while handling, or during application of the Linwax to the strands.

Study 6:

Introduction: The cost of linseed oil in the fall of 2004 nearly doubled due to a shortage of flax caused by a severe, wide spread, frost in August, 2004 across much of the flax growing area. An alternative formulation of the 70/30 linwax formulation was investigated. The original 70/30 linwax formulation consisted of 70% solids of wax (either petroleum or natural) and 30% linseed oil solids. This material was emulsified into a 60% solids emulsion with the remainder being water.

Purpose: An alternative material stream from soybean processing called acid oil was evaluated as a partial replacement for linseed oil. This was done to maintain the cost structure of the final emulsion as to be cost competitive with current commercial wax emulsions on the market.

Materials and Methods: An acid oil/linseed oil/petroleum wax emulsion was manufactured by Blended Waxes in Oshkosh, Wis., at the request of Archer-Daniels-Midland Company. The percentage of solids in the final 60% water based emulsion was 70% wax, 20% acid oil, and 10% linseed oil. The final material was shipped back to the Mankato Lab for evaluation.

Two sets of panels were manufactured. One set utilizing the new linwax formulation and the other set utilizing Borden Chemicals EW-58S wax emulsion. This emulsion was 58% solids, with the remainder being water.

Furnish was obtained from a Northern MN OSB facility and was comprised mainly of aspen with a percentage of birch, balm, ash, and red pine mixed in. Powder face and core resin was also obtained from Tembec Resin (Montreal, Canada).

Blending parameters were as follows:
Resin addition, 2.5% solids for both face and core;
Wax addition, 1.0% solids of either Borden or new linwax for both face and core;
Wax was applied via a Coil Spinning Disc Atomizer

Three layer mats were formed with the ratio of 30/40/30 for face:core:face configuration, respectively. Target final thickness of the panels was ½-inch at an density of 40 pcf. Press temperature was 410 degrees F. with a total press time of 3.5 minutes, including a degas step. Three, 21-inch by 21-inch panels per set were manufactured. They were allowed to hot stack overnight prior to cutting into test specimens.

Discussion and Results: From each panel, 10 internal bond specimens and 6 water absorption/thickness swell specimens were cut. Internal bond specimens allow for the determination of bond efficacy and potential resin interference. The water absorption and thickness swell specimens determine the resistance of the composite panel to water when submerged.

The following table summarizes the results of the testing:

| | Internal Bond | Water Absorption | Thickness Swell |
|---|---|---|---|
| Wax Type | (psi) | (%) | (%) |
| Borden EW-58S | 31.2 | 31.9 | 24.8 |
| Linwax | 33.4 | 27.7 | 18.8 |

The substitution of acid oil for linseed oil in the formulation of linwax emulsions appears to be an economic alternative for this line of wax. The emulsion is low in viscosity, near neutral in pH, and shear stable. When compared to commercially available wax emulsions, the performance is very similar and may be slightly better as observed with the 30% linseed oil formulations of linwax emulsions.

The data sets from all of the above studies indicate that Linwax does not adversely effect panel properties. In fact, Linwax can produce panels with similar properties. The benefits of mill running parameters of keeping the tanks and line clean should be a perceived benefit of the Linwax material over existing wax emulsions used in the forest products industry.

All patents and publications mentioned hereinabove are hereby incorporated in their entirety by reference.

While the foregoing invention has been described in some detail for purposes of clarity and understanding, it will be appreciated by one skilled in the art from a reading of this disclosure that various changes in form and detail can be made without departing from the true scope of the invention and appended claims.

1. A method of enhancing the mechanical strength and dimensional stability of composite boards and structures comprising:
(a) applying a combination of a homogeneous triglyceride and wax emulsion comprising a surfactant, and a bonding agent to fibrous plant or wood materials; and
(b) subjecting said materials to a press cycle to form a bonded fibrous composition.

2. A method of enhancing the mechanical strength and dimensional stability of composite boards and structures comprising:
(a) applying a combination of a slack form of a triglyceride and wax mixture, and a bonding agent to fibrous plant or wood materials; and
(b) subjecting said materials to a press cycle to form a bonded fibrous composition.

3. The method of claim 1, wherein said surfactant is selected from the group consisting of fatty acids, tall oils, sorbitan esters, phosphate esters, fatty alcohol ethoxylates, phosphate esters, sulphosuccinates, ligno sulphonates, polyester polyols, alcohol ethoxylates, soy lecithins, sorbitan oleates, caustics, sorbitan sterates, steric acids, palmitic acids, cetyl esters, polysorbates, glycerol sterates, polyethelyne glycols (PEG), cetyl alcohols, oleic acids, mono and diglyerides, sulfanates, linear alcohol sulfanates, and mixtures thereof.

4. The method of claim 1, wherein said triglyceride is selected from the group consisting of linseed oil, soybean oil, soy stearine oil, stearine oil, corn oil, cottonseed oil, rape seed oil, canola oil, sunflower oil, safflower oil, tung oil, castor oil, china wood oil, fish oil, lard, tallow, palm oil, palm kernel oil, coconut oil, crambe oil, peanut oil, tall oil, oiticica oil, animal fats, and mixtures thereof.

5. The method of claim 1, wherein said triglyceride is linseed oil.

6. The method of claim 1, wherein said wax is a petroleum wax.

7. The method of claim 6, wherein said petroleum wax is selected from the group consisting of petroleum scale, slack, paraffin, micro paraffin waxes, and mixtures thereof.

8. The method of claim 1, wherein said wax is a natural wax.

9. The method of claim 8, wherein said natural wax is selected from the group consisting of hydrogenated vegetable waxes (sterines) from soybean oil, corn oil, palm oil, cottonseed oil, canola oil, sunflower oil, safflower oil, animal fats, bees wax, carnuba wax, candelilla wax, bayberry wax, orange wax, and mixtures thereof.

10. The method of claim 1, wherein said bonding agent is selected from the group consisting of an adhesive resin, an emulsion of adhesive resin and water, a conjugated triglyceride co-adhesive, urea-formaldehyde, melamine-urea-formaldehyde, polyvinyl acetate, phenol formaldehyde, isocyanate, di-isocyanate, resorcinol-phenol-formaldehyde, protein, tannin-formaldehyde, sulfite liquor, and mixtures thereof.

11. The method of claim 1, wherein said fibrous plant or wood materials are selected from the group consisting of wood, wood fibers, agricultural fibers, agricultural materials, mixtures thereof, and mixtures of these materials with plastics or polymers.

12. The method of claim 1, wherein said homogeneous triglyceride and wax emulsion, and said bonding agent are applied separately to said fibrous plant or wood materials.

13. The method of claim 1, wherein said combination of a slack form of a triglyceride and wax mixture, and said bonding agent are applied separately to said fibrous plant or wood materials.

14. The method of claim 1, wherein said homogeneous triglyceride and wax emulsion and said bonding agent are blended into a mixture prior to application to said fibrous plant or wood materials.

15. The method of claim 1, wherein said combination of a slack form of a triglyceride and wax mixture, and said bonding agent are blended into a mixture prior to application to said fibrous plant or wood materials.

16. A composite board or structure made by the method of claim 1.

17. The composite board or structure of claim 16, wherein said composite board or structure is selected from the group consisting of oriented strand board (OSB), particle board, plywood, medium density fiberboard (MDF), hardboard, formed molded shapes, engineered I-beams, medium density fiberboard (MDF), hardboard, formed molded shapes, paper board, insulation board, corrugated cardboard, gypsum, fiberboard sheathing, and cement-fiber boards.

18. A composition for enhancing the mechanical strength and dimensional stability of composite boards and structures comprising a triglyceride, a wax, and a surfactant, wherein said composition is a homogeneous, stable emulsion.

19. A composition for enhancing the mechanical strength and dimensional stability of composite boards and structures comprising a slack form of a triglyceride and wax mixture, wherein said composition is a stable, slack (molten) material.

20. The composition of claim 18, wherein said triglyceride is selected from the group consisting of linseed oil, soybean oil, soy stearine oil, stearine oil, corn oil, cottonseed oil, rape seed oil, canola oil, sunflower oil, safflower oil, tung oil, castor oil, china wood oil, fish oil, lard, tallow, palm oil, palm kernel oil, coconut oil, crambe oil, peanut oil, tall oil, oiticica oil, animal fats, and mixtures thereof.

21. The composition of claim 18, wherein said wax is a petroleum wax.

22. The composition of claim 21, wherein said petroleum wax is selected from the group consisting of petroleum scale, slack, paraffin, micro paraffin waxes, and mixtures thereof.

23. The composition of claim 18, wherein said wax is a natural wax.

24. The composition of claim 23, wherein said natural wax is selected from the group consisting of hydrogenated vegetable waxes (sterines) from soybean oil, corn oil, palm oil, cottonseed oil, canola oil, sunflower oil, safflower oil, animal fats, bees wax, carnuba wax, candelilla wax, bayberry wax, orange wax, and mixtures thereof.

25. The composition of claim 18, wherein said surfactant is selected from the group consisting of fatty acids, tall oils, sorbitan esters, phosphate esters, fatty alcohol ethoxylates, phosphate esters, sulphosuccinates, ligno sulphonates, polyester polyols, alcohol ethoxylates, soy lecithins, sorbitan oleates, caustics, sorbitan sterates, steric acids, palmitic acids, cetyl esters, polysorbates, glycerol sterates, polyethelyne glycols (PEG), cetyl alcohols, oleic acids, mono and diglyerides, sulfanates, linear alcohol sulfanates, and mixtures thereof.

26. The composition of claim 18, wherein the pH of said composition is near neutral.

27. The composition of claim 18, wherein said wax and said triglyceride are in a relative proportion to each other equivalent to about 50% wax and about 50% triglyceride.

28. The composition of claim 18, wherein said wax and said triglyceride are in a relative proportion to each other equivalent to about 60% wax and about 40% triglyceride.

29. The composition of claim 18, wherein said wax and said triglyceride are in a relative proportion to each other equivalent to about 70% wax and about 30% triglyceride.

30. The composition of claim 18, wherein said wax and said triglyceride are in a relative proportion to each other equivalent to about 80% wax and about 20% triglyceride.

31. The composition of claim 18, wherein said wax and said triglyceride are in a relative proportion to each other equivalent to about 90% wax and about 10% triglyceride.

32. The composition of claim 18, wherein said stable emulsion is subjected to continuous mixing, stirring, or other form of agitation of said emulsion.
